(19) United States
(12) Patent Application Publication
(10) Pub. No.: US 2002/0041099 A1
(43) Pub. Date: Apr. 11, 2002

(54) Releasable pipe-connecting arrangement

(76) Inventor: Harald Grun, Gottmadingen (DE)

Correspondence Address: Gregory P. LaPointe, BACHMAN & LaPOINTE, P.C., 900 Chapel Street, Suite 1201, New Haven, CT, 06510-2802, US

(21) Appl. No.: 09/858,416

(22) Filed: May 16, 2001

(30) Foreign Application Priority Data
Aug. 24, 2000 (DE) 100 41 556.3

(51) Int. Cl. F16L 17/00

(52) U.S. Cl. 285/364

(57) ABSTRACT

The invention proposes a releasable pipe-connecting arrangement for connecting pipelines, comprising two matching plastic pipeline end regions designed in a flange-like manner, at least one sleeve which matches the pipeline end region and is made of stainless steel, a flexible seal arranged between the pipeline end regions, and a clamp for the releasable fastening of the pipeline end regions, the seal and the sleeve, the sleeve being arranged displaceable on the flange-like end region.

### BACKGROUND OF THE INVENTION

The present invention relates to a releasable pipe-connecting arrangement for connecting pipelines, comprising two matching plastic pipeline end regions designed in a flange-like manner, at least one sleeve which matches the pipeline end region and is made of stainless steel, a flexible seal arranged between the pipeline end regions, and a clamp for the releasable fastening of the pipeline end regions, the seal and the sleeve.

In industrial processing engineering, in particular in food production and in the pharmaceutical industry, pipelines are used in order to channel high-purity media. The pipeline material has to meet stringent requirements. It is necessary for the pipelines to be cost-effective and straightforward to produce, for the pipelines to be dismantled into individual parts as far as possible for cleaning purposes, for the material to be easy to clean and to withstand the sterilization temperature a number of times, and for the pipelines not to have any regions in which the flow speed of the medium is low or equal to zero, that is to say the pipelines must not have any dead spaces.

If two pipeline parts are connected to one another, the transitions between the individual pipeline parts have to be designed to be constant as much as possible, that is, without any change in diameter, without any seams and without any change in the material at the sealing location. The choice is between pipelines made of stainless steel or of plastic. Plastic pipelines have advantages in terms of weight and cost over pipelines made of steel. Up until now, pipelines have been made of plastics which cannot be sterilized and have had to be discarded following each use. Higher-grade plastics, for example PVDF (polyvinylidene fluoride), are reinforced in the flange region by sleeves made of stainless steel in order to absorb the high mechanical stressing which occurs. Overall, however, the flange region should be designed so as to ensure compatibility with the existing and standardized flanges and clamps.

EP 958 469 A2 discloses a pipe-connecting arrangement of the generic type. The pipeline end region, made of a first polymer material, is produced by plastic injection molding and, following the injection molding, is subjected to a high pressure and a sufficiently high temperature to shrink the flange region. The flange region then also has a reinforcement part, made of a second polymer material, extruded over it, this second polymer material having a higher strength than the first material. This extrusion operation and the temperature treatment produce a non-releasable connection between the pipeline end region and the reinforcement part.

Accordingly, it is the principle object of the present invention to provide a releasable pipe-connecting arrangement for connecting pipelines which can be dismantled straightforwardly into individual parts, can be sterilized a number of times and is of the smallest possible dimensions.

### SUMMARY OF THE INVENTION

The foregoing object is achieved by providing a releasable pipe-connecting arrangement for connecting pipelines, comprising two matching plastic pipeline end regions designed in a flange-like manner, at least one sleeve which matches the pipeline end region and is made of stainless steel, a flexible seal arranged between the pipeline end regions, and the clamp for the releasable fastening of the pipeline end regions, the seal and a sleeve, the sleeve being arranged displaceably in a releasable manner on the flange-end region.

It is advantageous that the pipe-connecting arrangement can be easily assembled. This is achieved in that the sleeve is arranged displaceably on the flange-end region.

It is also advantageous that the pipe-connecting arrangement can be sterilized a number of times, and that as little waste as possible is generated during the production of the sleeve. This is achieved in that the sleeve can be produced from stainless steel in a single-stage drawing or bending process.

It is also advantageous that the releasable pipe-connecting arrangement is compatible with the existing and standardized flanges and clamps for the releasable fastening of the pipeline end regions, the seal and the sleeve. This is achieved in that the sleeve has an external diameter which is essentially equal to the external diameter of the pipeline end region. This is also achieved in that the sleeve has an external diameter which is essentially smaller than or equal to the sum of the external diameter of the end region and the wall thickness of the pipeline.

It is also advantageous that the releasable pipeline connection attains good reinforcement and high pressure resistance in the flange region by way of a single part of straightforward design. This is achieved in that the sleeve is designed in a single piece in a rotationally symmetrical manner from stainless steel and has a collar region and a flange region adjoining the collar region, the collar region having an internal diameter coinciding with the external diameter of the pipeline, and the flange region being angled from the collar region such that the inside of the flange region is of the same shape as the flange-like pipeline end region.

### BRIEF DESCRIPTION OF THE DRAWINGS

An exemplary embodiment of the invention is described with reference to the figures, in which:

FIG. 1 shows a section through a pipe-connecting arrangement according to the invention,

FIG. 2 shows a section through part of the pipe-connecting arrangement from FIG. 1 prior to assembly,

FIG. 3 shows an enlargement of a certain region from FIG. 1,

FIG. 4 shows an enlargement of a certain region from a second exemplary embodiment, and

FIG. 5 shows an enlargement of a certain region from a third exemplary embodiment.

### DETAILED DESCRIPTION

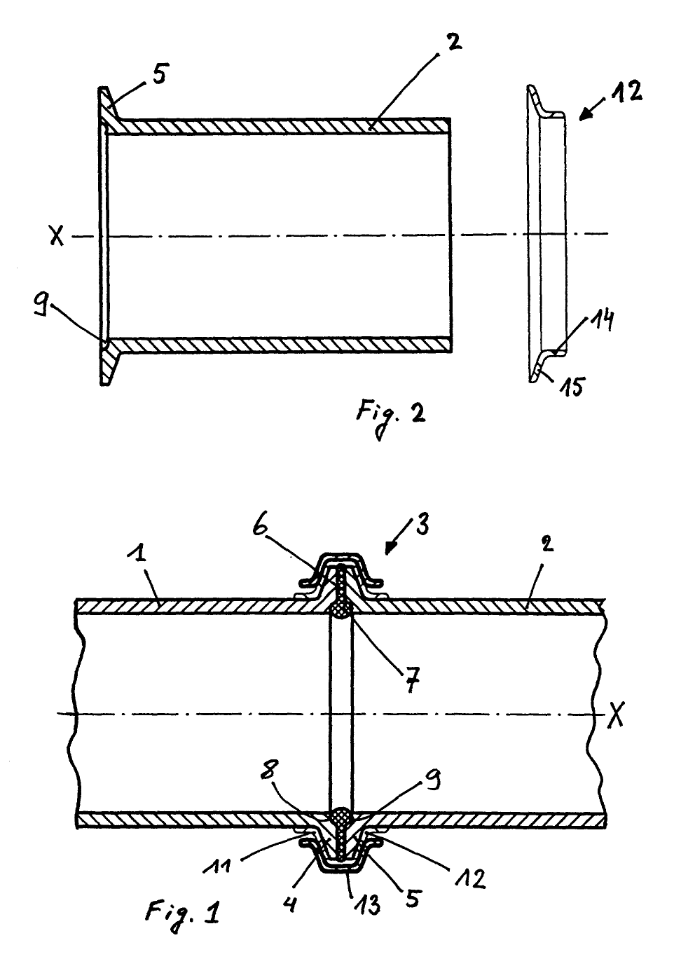

FIG. 1 is a schematic illustration, in section along the pipeline axis X of two pipelines 1, 2 which are produced, for example, from PVDF (polyvinylidene fluoride) or from some other high-grade plastic material and are used, for example, in food production and in the pharmaceutical industry. FIG. 1 illustrates a releasable pipe-connecting arrangement 3 for the releasable connection of the pipelines 1, 2. The releasable pipe-connecting arrangement 3 is designed in a rotationally symmetrical manner. The pipelines 1, 2 both have matching plastic end regions 4, 5 which are designed as flanges 4, 5. A seal 6 is arranged between the pipeline end regions 4, 5. The seal 6 is produced from a flexible material, for example elastomer or rubber. In the direction of the pipeline axis X, the flexible seal 6 has end surfaces which are essentially the same shape as the end surfaces of the pipeline end regions 4, 5. This achieves good adaptation of the seal 6 between the pipelines 1, 2. The seal 6 may also have an annular bead 7 which essentially fills a groove 8, 9 in the end region 4, 5 of the pipeline 1, 2. The seal 6 may also have an encircling lip 10 which adjoins the outer border of the seal and is described by way of the exemplary embodiments of FIGS. 4 and 5.

In each case one sleeve 11, 12 matching the end regions 4, 5 is here illustrated. The releasable pipe-connecting arrangement 3 is held together by a clamp 13 which encloses the end regions 4, 5 of the pipelines 1, 2 the seal 6 and the sleeves 11, 12 with clamping action. The clamp 13 is an existing and standardized clamp which is described, for example, in Standard ISO 2852, DIN 32676 or BS 4825 Part 3. The clamp 13 subjects the releasable pipe connection 3 to stressing which is of a sufficiently high level to hold the pipelines 1, 2 together such that they are sealed and free of dead spaces, that is to say without any regions in which the flow speed of the medium in the pipeline is low or equal to zero. The sleeves 11, 12 are produced stainless steel. The shape of the rotationally symmetrical sleeves 11, 12 is straightforward and can be produced in a single pass on a bending or pressing apparatus.

FIG. 2 illustrates a pipeline 2 and a sleeve 12 from FIG. 1 in section prior to assembly. It can be seen in FIG. 2 how the sleeve 12 can be fitted displaceably over the external diameter of the pipeline 2. The sleeve has a collar region 14 which has an internal diameter which coincides essentially with the external diameter of the pipeline 2. This means that the sleeve 12 can still just be pushed over the pipeline 2. This ensures a good fit of the collar region 14 on the outside of the pipeline 2. Adjoining the collar region 14, the sleeve 12 has a flange region 15, which is angled from the collar region 14 by a pressing or bending operation. The angled shape allows the inside of the flange region 15 to be of the same shape as the flange-pipeline end region 5. This likewise ensures a good fit of the sleeve 12 over the end region 5 of the pipeline 2. It can be seen from FIGS. 1 and 2 that the sleeve 12 has an external diameter which is essentially equal to the external diameter of the flange-end region 5 of the pipeline 2. This means that the sleeve 12 can easily be accommodated in the clamp 13 and that, in the clamped-on stage, the clamp 13 only transmits forces with an axial force vector to the end regions 4, 5 and the seal 6.

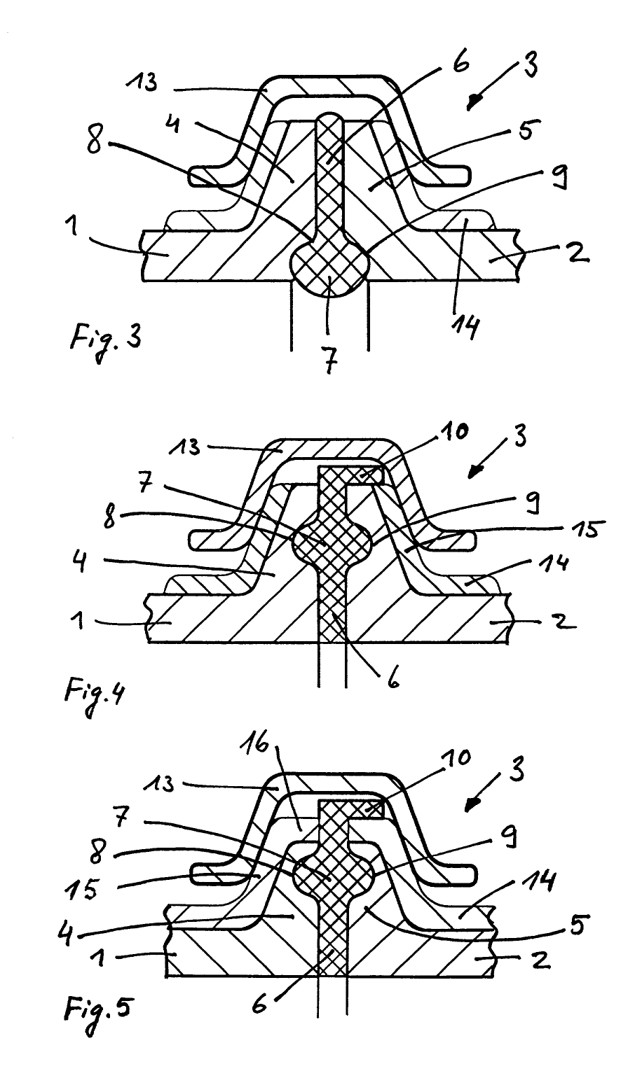

FIGS. 3, 4 and 5 illustrate, one after the other, three exemplary embodiments of the releasable pipe-connecting arrangement. FIG. 3 illustrates an enlargement of a detail from FIG. 1. In FIGS. 4 and 5, the seal 6 has an encircling lip 10. This makes more straightforward centering of the seal 6 on an end region 5 of the pipeline 2 possible. The assembly of the releasable pipe connection is facilitated to a considerable extent by the lip 10, which can be positioned in and annularly latching around the flange regions 5 of the pipeline 2 or around flange region 15 of the sleeve 12 in a space defined at least in part by the clamp and sleeve.

FIG. 5 illustrates a third exemplary embodiment of the releasable connection arrangement 3. In this case, the sleeve 11, 12 has an external diameter which is essentially no greater than the sum of the external diameter of the end region 4, 5 and the wall thickness of the sleeve 11, 12. The sleeve 11, 12 from FIG. 5 also has an encircling lip 16 adjoining the flange region 15. The lip 16 is of essentially the same wall thickness as the collar 14 of the sleeve 11, 12. This design of the sleeve 11, 12 is also displaceable in relation to the end region 4, 5 of the pipeline 1, 2 and also ensures compatibility with existing clamps 13. The lip 16 facilitates the assembly of the releasable pipe-connecting arrangement 3 and is used, in particular, for pipelines 1, 2 which have a relatively small external diameter in the end region 4, 5.

Slant-like end regions 4, 5 of different designs are illustrated in FIGS. 3 to 5. The external diameters of the plastic flanges 4, 5 are different and the grooves 8, 9 for accommodating the bead 7 are arranged at different radial differences from the pipeline axis X.

In the prior-art releasable pipe connection 3 of plastic pipelines, the flange-like end regions 4, 5 of the pipelines 1, 2 have always had to be of particularly reinforced design on account of the high mechanical stressing which occurs. It has been necessary for the flange reasons to be of relatively thick design in the axial direction. Excessively thick flange regions 4, 5 do not fit into the standardized clamp 13. Up until now, it has thus been necessary to make use of specially made, non-compatible clamps which are difficult to fit and have sharp edges. Using the stainless-steel sleeve 11, 12 according to the invention in the releasable pipe connection 3 means that the flange regions 4, 5 need not be of particularly thick design and that an existing and standardized clamp can be used. Without any further changes to the design or to the dimensions, it is possible to ensure a sufficiently good sealing action with a releasable pipe connection of plastic pipelines.

What is claimed is:

1. A releasable pipe-connecting arrangement for connecting pipelines comprising first and second pipelines having two matching plastic pipeline flanged end regions, at least one stainless steel sleeve which matches the pipeline end regions, a flexible seal arranged between the pipeline end regions, and a clamp for the releasable fastening of the pipeline end regions, the seal and the sleeve, wherein the sleeve is displaceably arranged on the flanged end region.

2. The releasable pipe-connecting arrangement for connecting pipelines as claimed in claim 1, wherein the sleeve has an internal diameter which is essentially equal to the external diameter of the flanged end region.

3. The releasable pipe-connecting arrangement for connecting pipelines as claimed in claim 1, wherein the sleeve has an internal diameter which is essentially smaller than or equal to the sum of the external diameter of the end region and the wall thickness of the sleeve.

4. The releasable pipe-connecting arrangement for connecting plastic pipelines as claimed in claim 3, wherein the sleeve is a single piece in a rotationally symmetrical manner and has a collar region and a flange region adjoining the collar region, the collar region having an internal diameter coinciding with the external diameter of the pipeline, and the flange region being angled from the collar region such that the inside of the flange region is of the same shape as the flange-like pipeline end region.

5. The releasable pipe-connecting arrangement for connecting pipelines as claimed in claim 1, wherein a sleeve is associated with each flanged end region of the first and second pipelines.

6. The releasable pipe-connecting arrangement for connecting pipelines as claimed in claim 2, wherein the seal projects into a space defined at least in part by the sleeves and clamp.
